(19) United States
(12) Patent Application Publication
(10) Pub. No.: US 2007/0052703 A1
(43) Pub. Date: Mar. 8, 2007

(54) Display device

(75) Inventor: Tatsuya Seto, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/515,792

(22) Filed: Sep. 6, 2006

(30) Foreign Application Priority Data
Sep. 6, 2005 (JP) 2005-258351
Sep. 6, 2005 (JP) 2005-258350

(51) Int. Cl. G06T 15/00

(52) U.S. Cl. 345/419

(57) ABSTRACT

A display device has an indicator and a control unit. The indicator has a display element for displaying image information. The control unit controls the indicator to perform a three-dimensional visual display such that an image is visualized three-dimensionally and a two-dimensional visual display such that an image is visualized two-dimensionally. Further, the control unit controls the indicator to perform the two-dimensional visual display with respect to specific information of the image information. Also, the control unit controls the indicator to display an informing image as a three-dimensional and moving image, at a predetermined informing time.

### CROSS REFERENCE TO RELATED APPLICATION

This application is based on Japanese Patent Application No. 2005-258350 filed on Sep. 6, 2005 and No. 2005-258351 filed on Sep. 6, 2005, the disclosure of which are incorporated herein by reference.

### FIELD OF THE INVENTION

The present invention relates to a display device that displays image information three-dimensionally.

### BACKGROUND OF THE INVENTION

In a display device such as an instrument for a vehicle, it is known to use a liquid crystal panel having a flat plate shape and to display an instrument design, various kinds of information and warning information on the liquid crystal panel.

Further, it is known to visualize information three-dimensionally by a parallax barrier method or a lenticular lens method so as to improve an appearance of image displayed on the display device. In the parallax barrier method or the lenticular lens method, a right eye image and a left eye image are displayed on the liquid crystal panel to be visualized by the right eye and the left eye of a viewer, respectively. As such, the image is three-dimensionally visualized by a parallax of the right and left eyes of the viewer.

In such a display device, it is also known to display a character three-dimensionally such that the character speaks words while moving. This kind of display device is for example disclosed in Japanese Patent Publication No. 2003-137006.

However, in such a three-dimensional visual display method, an image separation is performed so that the right eye sees only the right eye image and the left eye sees only the left eye image, and the three-dimensional image is constructed of the right eye image and the left eye image. Therefore, a display resolution of the three-dimensional image is reduced in principle. Further, this three-dimensional display system has the character that the three-dimensional image will not be successfully focused and will be disturbed, when a visual point of the viewer moves such as leftward and rightward.

Therefore, in a case that image information such as an instrument is displayed in the above three-dimensional visual display method, for example, it is difficult to accurately display or project information depending on the display content of the image information. Also, when the visual point of the viewer moves leftward and rightward, it is difficult to accurately visualize the image information.

### SUMMARY OF THE INVENTION

The present invention is made in view of the foregoing matter, and it is a first object to provide a display device capable of reconciling an enhanced appearance by three-dimensional visual display and resolution by two-dimensional visual display in displaying image information.

It is a second object to provide a display device capable of raising visual recognition property of an informing image at a time of informing.

According to a first aspect of the present invention, a display device has an indicator and a control unit. The indicator has a display element in a form of flat plate for displaying image information. The control unit controls operation of the display element. For example, the control unit controls the indicator to perform a three-dimensional visual display such that an image is visualized three-dimensionally and a two-dimensional visual display such that an image is visualized two-dimensionally. Further, the control unit controls the indicator to perform the two-dimensional visual display with respect to a specific information of the image information.

For example, the specific information includes a display content that are required to be accurately informed to the viewer. In the above indicator, the specific information is two-dimensionally displayed while the image information other than the specific information is three-dimensionally displayed. Accordingly, an appearance of the image information is improved by combination of the two-dimensional visual display and the three-dimensional visual display.

Further, since the specific information is two-dimensionally displayed, display resolution of the specific information will not be reduced. Even if a visual point of a user moves such as rightward and leftward, the display image of the specific information will not be disturbed. Accordingly, the specific information can be accurately informed to the viewer. Namely, the display device improves a display appearance without reducing the display resolution.

According to a second aspect of the present invention, the control unit controls the indicator to display an informing image as a three-dimensional and moving image at a predetermined informing time.

Accordingly, a producing effect and a visual recognition of the informing image can be improved. For example, the informing image has at least one of a transitional movement, rotational movement, zooming movement and flashing movement.

The above display devices are for example mounted to a vehicle, in front of a driver's seat for indicating information relative to the vehicle and information that does not relate to the vehicle. Information important for driving is two-dimensionally displayed in the three-dimensional display image. Thus, the important information is accurately informed to a driver. For example, warning information or other information required to be highly informed to the driver are displayed as the three-dimensional and moving image. Thus, the visual recognition of the driver improves.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic perspective view of a display device mounted on a vehicle as a combination meter, according to a first example embodiment of the present invention;

FIG. 2 is an enlarged partial cross-sectional view of the display device taken along a line II-II of FIG. 1;

FIG. 3 is an explanatory view of a display panel of the display device for showing a three-dimensional display area and a two-dimensional display area, according to the first example embodiment;

FIG. 4 is a schematic block diagram of the display device according to the first example embodiment;

FIG. 5 is an explanatory view for explaining various kinds of display information displayed on a liquid crystal panel of the display device according to the first example embodiment;

FIG. 6 is a flow chart for showing a control operation of the display device according to the first example embodiment;

FIG. 7 is an explanatory plan view of a screen of the liquid crystal panel for explaining a display image in a welcome message producing mode according to the first example embodiment;

FIG. 8 is an explanatory plan view of the screen of the liquid crystal panel in a normal display mode according to the first example embodiment;

FIG. 9 is an explanatory plan view of the screen of the liquid crystal panel in an abnormality display mode according to the first example embodiment;

FIG. 10A is an explanatory view for explaining an example operation for three-dimensionally displaying a symbol mark image as a moving image, according to a second example embodiment of the present invention;

FIG. 10B is an explanatory view for explaining another example operation for three-dimensionally displaying a symbol mark image as a moving image, according to the second example embodiment;

FIG. 10C is an explanatory view for explaining further another example operation for three-dimensionally displaying a symbol mark image as a moving image, according to the second example embodiment;

FIG. 11 is an explanatory plan view of a screen of a liquid crystal panel of a display device in an abnormality display mode in which the symbol mark image is three-dimensionally displayed as a moving image according to the second example embodiment;

FIG. 12 is an explanatory plan view of a screen of a liquid crystal panel of a display device in an abnormality display mode according to a modification of the second example embodiment of the present invention;

FIG. 13A is an explanatory plan view of a display device according to another example embodiment of the present invention;

FIG. 13B is an explanatory plan view of a display device according to further another example embodiment of the present invention; and

FIG. 14 is a schematic block diagram of a display device according to still another example embodiment of the present invention.

### DETAILED DESCRIPTION OF EXAMPLE EMBODIMENT

### First Example Embodiment

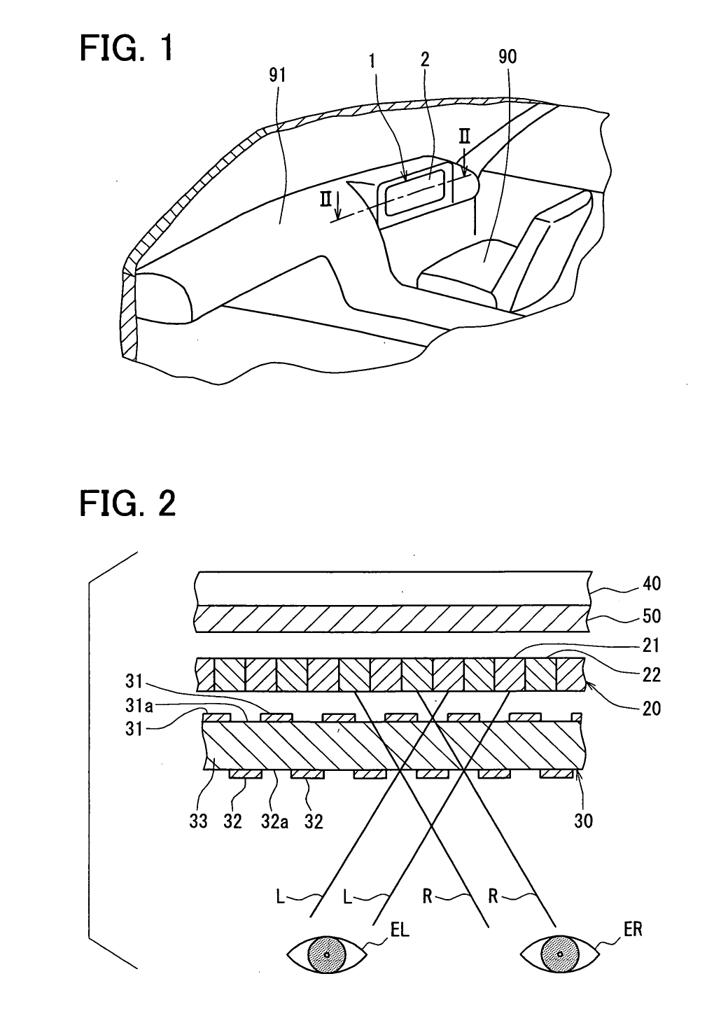

A first example embodiment of a display device of the present invention will now be described with reference to FIGS. 1 to 9. The display device is for example employed to a combination meter for a vehicle. However, use of the display device of the present invention is not limited to the meter for a vehicle, but can be also employed as a general instrument or a general display device.

(Structure of Display Device)

As shown in FIG. 1, the combination meter 1 is generally arranged at a location where a viewer e.g., a driver can easily see it. For example, the combination meter 1 is arranged in front of a driver's seat 90 of the vehicle along an instrument panel 91. The combination meter 1 includes a flat indicator 2 for properly displaying vehicle information and non-vehicle information so that the driver can see the information. The indicator 2 is for example composed of a liquid crystal panel 20 as a display panel.

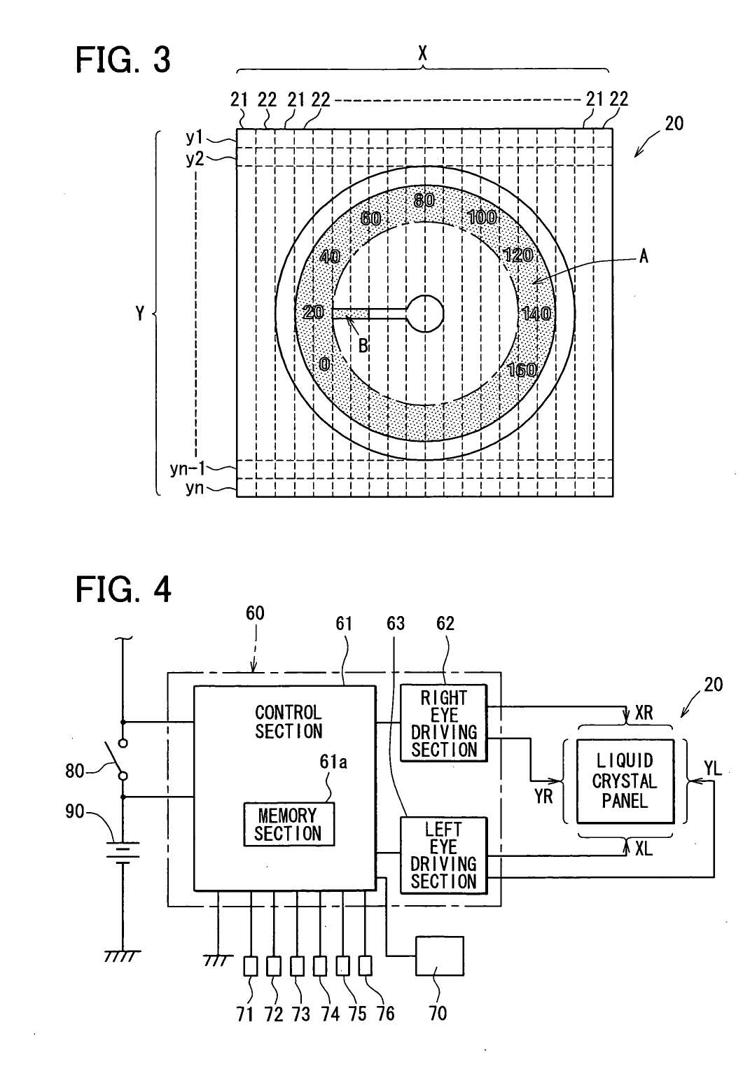

The liquid crystal panel 20 is controlled such that patterns of band shape portions 21, 22 as plural display elements are formed or drawn as an image on its display screen, as shown in FIGS. 2 and 3. The band shape portions 21, 22 extend in the vertical direction, i.e., in a direction perpendicular to the paper face in FIG. 2 and in a Y-arranging direction in FIG. 3, at a constant width. The band shape portions 21, 22 are alternately arranged with respect to the left and right direction of the paper face in FIG. 2, and an X-arranging direction in FIG. 3.

Each of the band shape portions 21, 22 is connected to a liquid crystal control unit 60, which will be described later. The liquid crystal panel 20 is operated by the liquid crystal control unit 60 in X-Y matrices so that an image for the left eye (hereafter, left eye image) is displayed in each band shape portion 21 and an image for the right eye (hereafter, right eye image) is displayed in each band shape portion 22.

The left eye image displayed in each band shape portion 21 and the right eye image displayed in each band shape portion 22 are selectively visualized by the left eye EL and the right eye ER of the viewer by an operation of a transparent cover 30, which constitutes a three dimension forming member or a three-dimensionally visualizing member described later. Accordingly, a display image is three-dimensionally visualized by a parallax of the left and right eyes.

On the other hand, when the left eye image and the right eye image displayed on the respective band shape portions 21, 22 are the same image, the right eye and the left eye see the same image. Namely, when there is no parallax between the right eye and the left eye, the display image is visualized in a plane, i.e., two-dimensional.

The liquid crystal panel 20 is not operated such that an entire display area is always visualized three-dimensionally. Namely, a particular area (particular image) of the display area is visualized two-dimensionally, the particular area requiring resolution with respect to the visualized display image. The liquid crystal panel 20 can be operated such that a two-dimensional visual display and a three-dimensional visual display are performed in the display area.

For example, in a display area A for displaying character information and physical values such as scales and numerical letters of an indication instrument and a display area B for displaying a pointer of the indication instrument, images are displayed two-dimensionally, as shown in FIG. 3. In a display area other than the display areas A and B, images are displayed three-dimensionally.

The transparent cover 30 is arranged over a display surface, which faces the driver's seat 90, of the liquid crystal panel 20. For example, the transparent cover 30 entirely covers the display surface of this liquid crystal panel 20 so that the three-dimensional visual display can be performed entirely over the display area. In this transparent cover 30, a parallax barrier method is adopted.

The transparent cover 30 has a sheet portion 33 that is for example made of transparent polycarbonate resin. Light interrupting bands 31, 32 are formed on both front and rear faces of the sheet portion 33 as parallax slit members. For example, the light interrupting band 31 is formed on the rear surface of the sheet portion 33 that faces the liquid crystal panel 20 and the light interrupting band 32 is formed on the front surface of the seat portion 33 that faces the driver's seat 90 by respectively printing or hot-stamping a frosting black paint in a band pattern.

The width of each of the light interrupting bands 31, 32 is the same as the width of each of the band shape portions 21, 22 of the liquid crystal panel 20. The respective light interrupting bands 31, 32 are spaced at the same intervals as the width of the band shape portion 21, 22 and are formed at an equal pitch in the left and right direction (the left and right direction of the paper face in FIG. 2, and the X-arranging direction in FIG. 3). Further, light passing ports 31a, 32a are formed at locations corresponding between the respective band shape portions 21, 22. Positions of the light interrupting bands 31, 32 of the sheet portion 33 are shifted by a 1/2 pitch in the left and right direction (X-arranging direction), with respect to the band shape portions 21, 22.

Further, a light source 40 and a diffusing plate 50 are arranged on the rear side of the liquid crystal panel 20. The light source 40 has a plate shape and constitutes a backlight. The diffusing plate 50 is provided to uniform face luminance of light from the light source 40.

Next, a visualizing state of the liquid crystal panel 20 will be described.

As shown in FIG. 2, a line R passing through one light passing port 31a and adjacent light passing port 32a in the rightward direction is consistent with a line connecting the band shape portion 22 and the right eye ER of the viewer. Namely, light emitted from the band shape portion 22 for displaying the right eye image passes through the light passing ports 31a, 32a and is incident on the right eye ER of the viewer. On the other hand, light emitted from the band shape portion 21 for displaying the left eye image is interrupted by the light interrupting bands 31, 32, and is therefore not incident on the right eye ER of the viewer.

Similarly, a line L passing through one light passing port 31a and adjacent light passing port 32a in the leftward direction is consistent with a line connecting the band shape portion 21 and the left eye EL of the viewer. Namely, light emitted from the band shape portion 21 for displaying the left eye image passes through the light passing ports 31a, 32a and is incident on the left eye EL of the viewer. On the other hand, light emitted from the band shape portion 22 for displaying the right eye image is interrupted by the light interrupting bands 31, 32, and is therefore not incident on the left eye EL of the viewer.

As such, the right eye image displayed in the band shape portion 22 is visually recognized by the right eye ER of the viewer, and simultaneously the left eye image displayed in the band shape portion 21 is visually recognized by the left eye EL of the viewer. As such, the display images are synthesized and visually recognized as a three-dimensional image.

For example, the liquid crystal panel 20 is operated such that the display image is separated into an image signal for the right eye and an image signal for the left eye, and the band shape portion 21 and the band shape portion 22 of the liquid crystal panel 20 are simultaneously operated by the image signal for the left eye and the image signal for the right eye. Therefore, the display image is visually recognized as the three-dimensional image.

On the contrary, if the right eye image and the left eye image are set to the same, the parallax of the images visualized by the right and left eyes is removed. Therefore, the display image is visually recognized as a plane image, i.e., a two-dimensional image.

(Control Construction)

Next, a control operation of the combination meter 1 will be described. As shown in FIG. 4, the combination meter 1 is controlled by the liquid crystal control unit (hereafter, control unit) 60. The control unit 60 is constructed of a micro computer including a CPU, a ROM and a RAM, and peripheral circuits. The control unit 60 is always supplied with electric power from a battery 90. The liquid crystal panel 20 is connected to the control unit 60.

Further, an ignition switch 80 of the vehicle, a speaker 70 for an alarm or a voice guide, various kinds of sensors 71 to 75 for detecting conditions of the vehicle, and a door switch 76 for detecting opening and closing of a vehicle door are connected to the control unit 60. The speaker 70 can be built in the combination meter 1. Alternatively, a separate acoustic device can be utilized as the speaker 70.

Here, the control unit 60 operates the liquid crystal panel 20 on the basis of detecting signals from various kinds of sensors 71 to 76 so that vehicle information and non-vehicle information are appropriately displayed. In accordance with necessity, the control unit 60 further operates the speaker 70 in association with the display on the liquid crystal panel 20 so as to generate an alarm sound, an effect sound, a voice or the like.

This control unit 60 includes a control section 61, a memory section 61a, a right eye driving section 62 and a left eye driving section 63. The control section 61 processes detecting signals from various kinds of sensors 71 to 76, and determines image information to be displayed in the liquid crystal panel 20.

The memory section 61a previously stores various kinds of image information to be displayed in the liquid crystal panel 20 in accordance with the detecting signals and various kinds of conditions as a data map. The right eye driving section 62 operates the band shape portions 22 by converting a control signal from the control section 61 into the image signal for the right eye. The left eye driving section 63 operates the band shape portions 21 by converting the control signal from the control section 61 into the image signal for the left eye. The memory section 61a is constructed of the ROM included in the control section (microcomputer) 61. Alternatively, the memory section 61a can be constructed of an external memory.

Here, the right eye driving section 62 designates a pixel of each band shape portion 22 by using an X-address (XR) and a Y-address (YR) assigned to each band shape portion 22, and controls a display state of each designated pixel. In this case, in the band shape portions 22, different image information is selected between a first display area (an area except for areas A and B of FIG. 3) for performing three dimensional visual display by giving a parallax to the viewer, and a second display area (areas A and B of FIG. 3) for performing two dimensional visual display without giving the parallax to the viewer.

Likewise, the left eye driving section 63 designates a pixel of each band shape portion 22 by using an X-address (XL) and a Y-address (YL) assigned to each band shape portion 21, and controls a display state of each designated pixel.

Accordingly, all image information to be displayed in the liquid crystal panel 20 is stored in the memory section 61a. The control section 61 determines a display screen in accordance with the detecting signals and various kinds of conditions, and reads out the image information required to the display screen from the data map stored the memory section 61a. As such, the control section 61 controls the liquid crystal panel 20 to display predetermined image information.

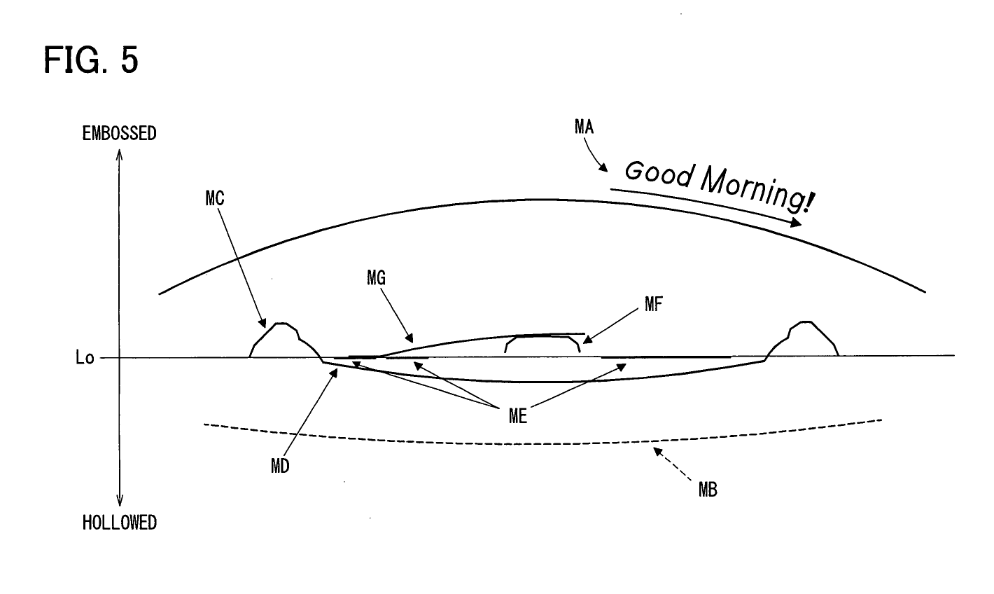

As shown in FIG. 5, various display contents are created as three-dimensional images by selectively controlling the right eye image produced on the band shape portion 22 and the left eye image produced on the band shape portion 21. For example, an embossing degree (embossed/raised appearance) or a depth degree (hollowed appearance) from a display surface L₀ of the liquid crystal panel 20 can be produced as the three-dimensional image by selectively controlling the right eye image and the left eye image the control unit 60 in accordance with the display contents. Further, a quality appearance and a gloss of each material can be produced for the display contents by selectively controlling of a color tone and brightness.

Hereafter, examples of producing the display contents will be described referring to FIG. 5.

First, in a production display mode MA, a welcome message such as “Good Morning!” is repeatedly displayed while moving from the left-hand side to the right-hand side of the display screen along a horizon that is greatly embossed from the display surface L₀.

In a virtual image background display mode MB, a background having a pattern such as a gradation pattern and a starry sky pattern is displayed with a comparatively large depth. The virtual image background display mode is utilized for displaying the background in displaying a warning, for example.

In a decorative design shape display mode MC, a decorative design portion is displayed. For example, a decorative ring decorating a contour of the indication instrument is displayed as the decorative design portion. Further, the decorative ring is displayed to be embossed and have a gloss such that its outer peripheral side has a metal-like appearance and its inner peripheral side has an acryl-like appearance, for example.

In a dial plate design shape display mode MD, a dial plate of the indication instrument is displayed. For example, a dial plate having a depth appearance in which the depth degree slightly increases from its outer peripheral portion to a central portion is displayed.

In a two-dimensional display mode ME, information that requires resolution such as the scales, the numbers and characters are two-dimensionally displayed.

In a pointer hub shape display mode MF, a central potion of the pointer of the indication instrument is displayed to have a glossy appearance such as a metal-like appearance and to be embossed.

In a pointer shape display mode MG, only a distal end of the pointer, which extends from the pointer hub (central portion), is two-dimensionally displayed since the resolution is required. Alternatively, the pointer can be entirely displayed in two dimensional.

In the above metal-like appearance and acryl-like appearance mean appearances having brightness or glossiness similar to those of a metal and acrylic resin, respectively.

Here, an instrument face of a general analog type indication instrument provided with three-dimensional decorative members is reproduced as the image of the indication instrument displayed on the liquid crystal panel 20, for example. In this case, all image information is not three-dimensionally displayed. Specific information of all the image information, which is needed to be accurately informed to the viewer, e.g., driver, is displayed two-dimensionally, as the specific information.

Further, the specific information includes information indicating the physical values and character information. For example, the specific information means important display information such as the pointer, the scales, the numbers and the characters relating to indication contents of the indication instrument.

(Operation)

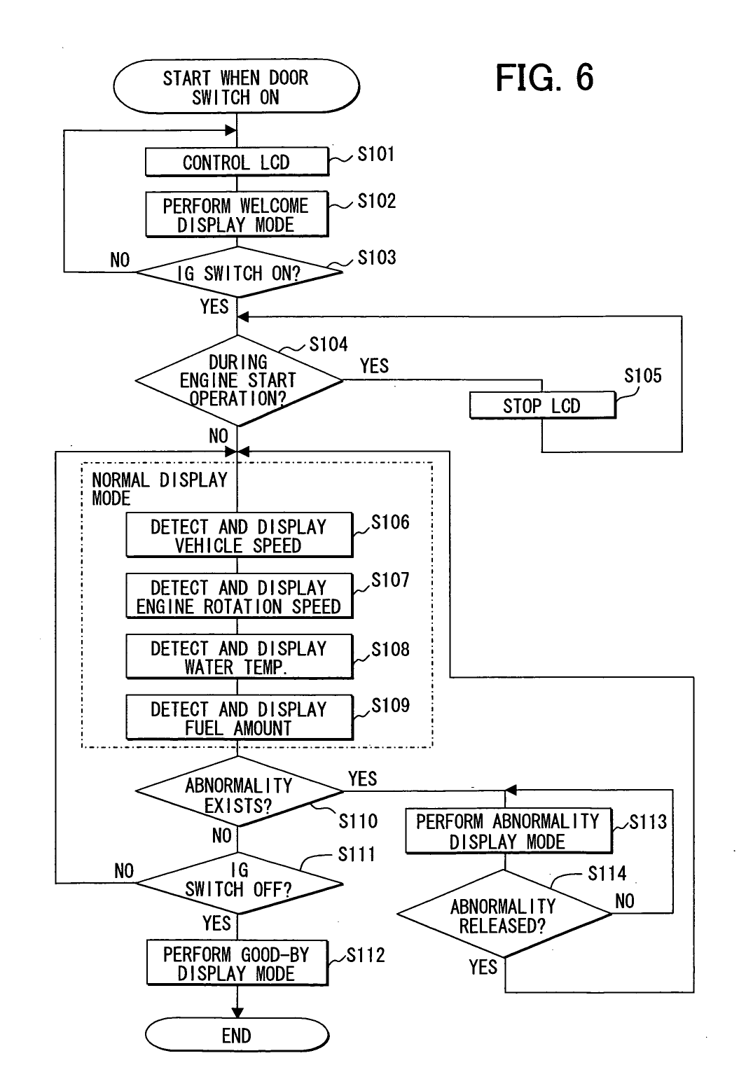

Next, an operation of the combination meter 1 will be explained with reference to a flow chart shown in FIG. 6.

Here, an example of the display operation will be sequentially described in a process from when the driver opens the door, rides in the vehicle and turns on the ignition switch 80 until the driver turns off the ignition switch 80.

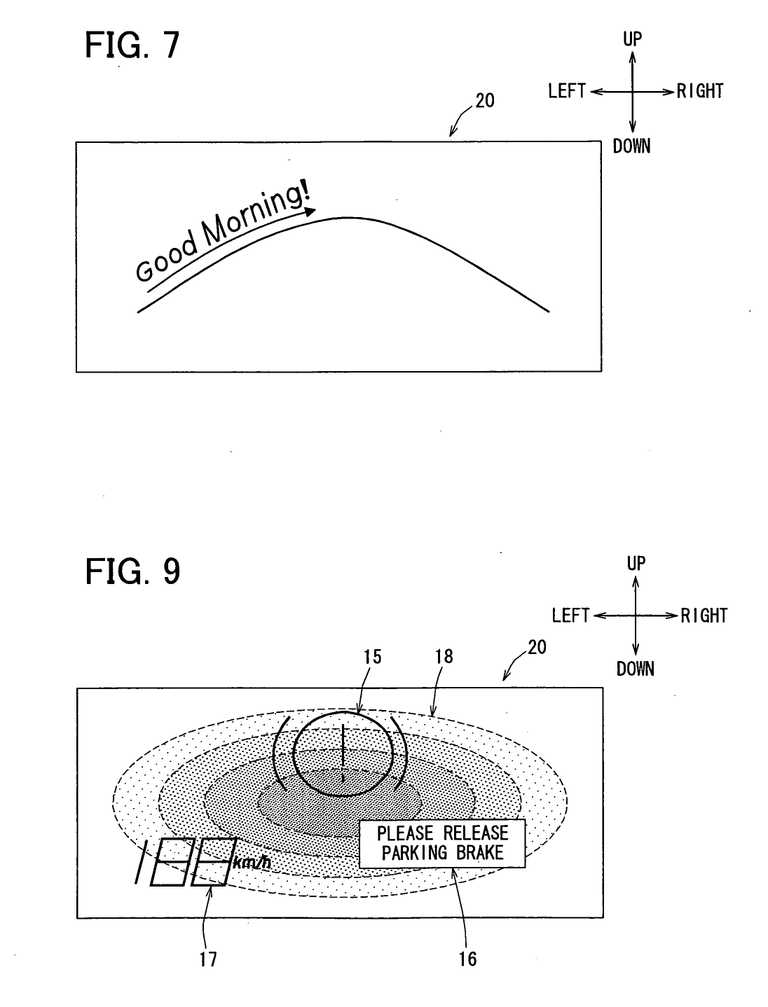

When the door switch 76 is off, the control section 61 is in a sleep mode in which an operation remains substantially at halt, and processing shown in the flow chart of FIG. 7 is not executed. Accordingly, the liquid crystal panel 20 is not operated, and nothing is displayed in the liquid crystal panel 20.

When the door switch 76 is turned on, the control section 61 receives a door opening signal indicating a door opening state from the door switch 76. Accordingly, the control section 61 becomes in a Wakeup mode from the Sleep mode, and starts processing shown in the flow chart of FIG. 6.

First, in step S101, the liquid crystal panel 20 is operated so that the liquid crystal display control can be performed. Next, in step S102, pertinent image information (information for the right eye image and information for the left eye image) is read out of the memory section 61a to perform the welcome message producing display mode MA with respect to the liquid crystal panel 20.

As such, the welcome message producing display mode MA is started by controlling the operation of the liquid crystal panel 20 on the basis of the read image information. Then, in step S103, it is determined whether the ignition switch 80 is on. When it is determined that the ignition switch 80 is off at the step S103, the processing returns to the step S101. Therefore, the welcome message producing display mode MA is continued while the ignition switch 80 is in off condition.

As shown in FIG. 7, the welcome message producing display mode MA is a three-dimensional moving image display mode for displaying non-vehicle information three-dimensionally while moving as an informing image. For example, the character image of “Good Morning!” is repeatedly displayed as the specific image while moving along the horizon that is greatly embossed from the display surface L₀ from the left-hand side to the right-hand side of the liquid crystal panel 20. In this case, the horizon and the character image are visualized so as to be embossed from the liquid crystal panel 20 as a three-dimensional image. As such, a producing effect can be improved.

For example, the producing effect can be further improved by setting color tones of the horizon, the character and the background area to color tones having contrast, and changing these color tones with the time. Further, at this time, for example, if a voice message such as “Hello, please have a safety drive!” is outputted from the speaker 70 by a female voice, the producing effect can be further improved. In addition, the producing effect can be further improved by adding moving image display of a character such as an animal or a person.

When the ignition switch 80 is turned on, the welcome message producing display mode MA is immediately stopped. In step S104, it is determined whether an engine starting operation is being performed. When it is determined that the engine starting operation is performed, the processing proceeds to step S105. In the step S105, the liquid crystal display control is stopped during a period of the engine starting operation. This is because a battery voltage is reduced and is greatly changed during the period of the engine starting operation. Sine the liquid crystal display control is stopped, unstable display of the liquid crystal display 20 is avoided and electric power is preferentially supplied to start the engine.

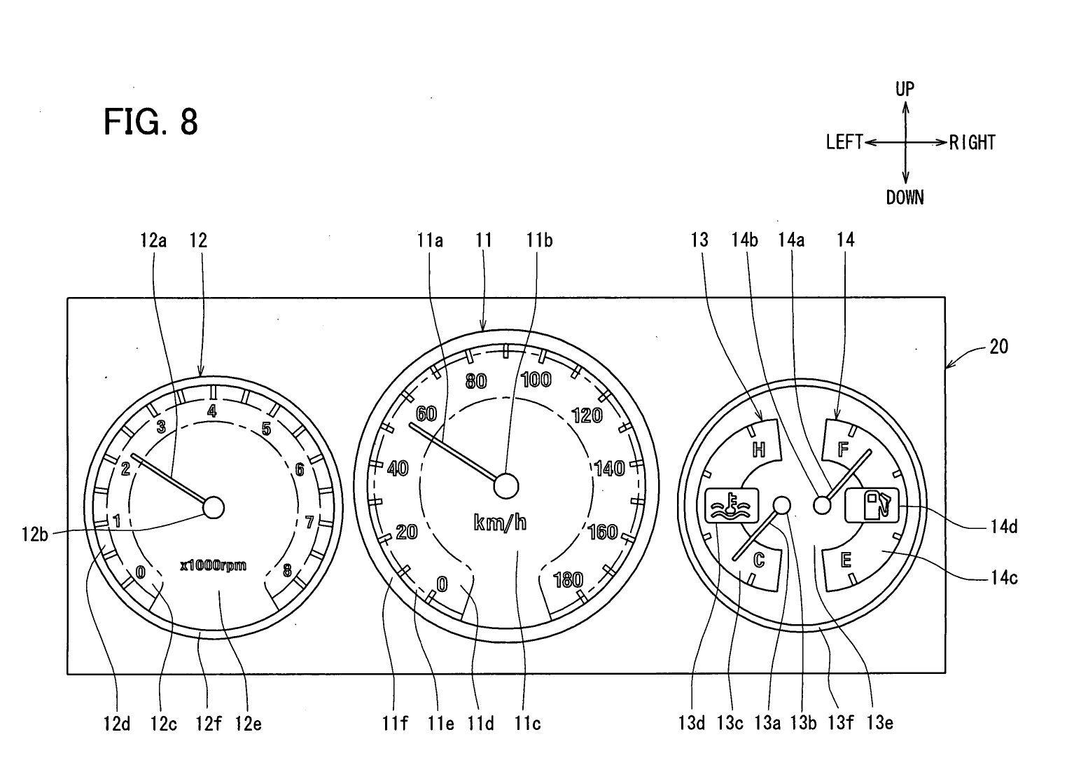

After the engine started, the processing proceeds to steps S106 to S109. As shown in FIG. 8, a normal display mode for displaying the vehicle information is started. For example, images of a speed meter 11, a tachometer 12, a water temperature meter 13 and a fuel gauge 14 are displayed in the liquid crystal panel 20 in forms of indication instruments having pointers.

The images of the indication instruments 11 to 14 are respectively displayed by appropriately controlling the operation of the liquid crystal panel 20 by the control unit 60 on the basis of detecting signals from the various sensors 71 to 74. For example, the sensors 71 to 74 are a vehicle speed sensor, an engine rotation sensor, a water temperature sensor and a fuel liquid face sensor, respectively.

Next, display control processing for displaying the images of the respective indication instruments 11 to 14 will be explained.

First, in step S106, a vehicle speed is detected on the basis of a vehicle speed signal from the vehicle speed sensor 71 shown in FIG. 4. A position of a pointer 11a of the speed meter 11 is determined on the basis of this detected vehicle speed information. Thus, an image of a speed meter 11 is displayed in the liquid crystal panel 20, as shown in FIG. 8.

In this case, image data for making the image of the speed meter 11 is stored in the memory section 61a in advance in forms of image data for the right eye to be given to the band shape portions 22 and image data for the left eye to be given to the band shape portions 21. Further, plural image data for showing respective positions of the pointer 11a within its rotational movement range are prepared and stored in the memory section 61a as pointer image data displaying the pointer 11a such that an appropriate image data can be selected on the basis of the vehicle speed information.

Furthermore, the above image data is in advance set to a data construction so that the display image is three-dimensionally or two-dimensionally displayed in accordance with the display areas. For example, image data for performing the two dimensional visual display is set in areas for displaying a pointer image 11a, a portion of a scale image and a number image 11d. Also, image data for performing the three-dimensional visual display is set in an area for displaying a pointer hub image 11b, a dial plate image 11c, an acrylic tone ring image 11e with a scale, and a metallic tone decoration ring image 11f.

Therefore, the pointer image 11a, a portion of the scale image and the number image 11d are displayed two-dimensionally. Also, the dial plate image 11c is displayed in a three-dimensional shape having a gentle depth or hollowed appearance. Further, the pointer hub image 11b, the acrylic tone ring image 11e with the scale and the metallic tone decoration ring image 11f are displayed in three-dimensional shapes embossed from the display surface L₀ with respective color tones and quality appearances.

Thus, producing effects of the pointer hub image 11b and the respective decoration ring images 11e, 11f of the indication instrument are emphasized by the color tones and the three-dimensional images. Further, the specific information such as the pointer image 11a and the scale and number image 11d, which requires resolution as the indication instrument, are two-dimensionally displayed. Accordingly, the resolution of the specific information will not be reduced. In addition, an indicating position of the pointer image 11a and the indicating values of the scale and number image 11d can be properly displayed. Furthermore, even when the driver's sight lines are shifted, it is less likely that the display image of the specific information will be disturbed.

Next, in step S107, an engine rotation speed is detected on the basis of a rotation speed signal from the engine rotation speed sensor 72 shown in FIG. 4. A position of a pointer 12a of the tachometer 12 is determined on the basis of this detected rotation speed information. Thus, an image of the tachometer 12 is displayed in the liquid crystal panel 20, as shown in FIG. 8.

In this case, similar to the image data for the speed meter 11, image data for making the image of the tachometer 12 is stored in the memory section 61a in advance in forms of image data for the right eye to be given to the band shape portions 22 and image data for the left eye to be given to the band shape portions 21. Further, plural image data showing respective positions of the pointer 12a within a rotational movement range are prepared and stored in the memory section 61a in advance as pointer image data for displaying the pointer 12a such that an appropriate image data can be selected on the basis of the engine rotation speed.

Furthermore, the above image data are image data for performing the two-dimensional visual display in an area for displaying a pointer image 12a, a number image 12c and a scale image 12d, and performing the three-dimensional visual display in an area for displaying a pointer hub image 12b, a dial plate image 12e and an acrylic tone ring image 12f.

Therefore, the pointer image 12a, the number image 12c and the scale image 12d are displayed in two-dimensional so that resolution thereof will not be reduced. Also, the dial plate image 12e is displayed in the three-dimensional shape having a gentle depth or hollowed appearance. The pointer hub image 12b and the acrylic tone ring image 12f are displayed in the three-dimensional shapes embossed with respective color tones and quality appearances.

Next, in step S108, the temperature of engine cooling water is detected on the basis of a water temperature signal from the water temperature sensor 73 shown in FIG. 4. A position of a pointer 13a of the water temperature meter 13 is determined on the basis of the detected cooling water temperature. Thus, an image of the water temperature meter 13 is displayed in the liquid crystal panel 20, as shown in FIG. 8.

Further, in step S109, the amount of fuel remaining in a fuel tank is detected on the basis of a detecting signal from the liquid face sensor 74. A position of a pointer 14a of the fuel gauge 14 is determined on the basis of this detected remaining fuel amount. Thus, an image of the fuel gauge 14 is displayed in the liquid crystal panel 20, as shown in FIG. 8.

Similar to the image data of the speed meter 11 and the tachometer 12, image data for making the images of instruments 13, 14 are stored in the memory section 61a in advance in the forms of image data for the right eye to be given to the band shape portions 22 and image data for the left eye to be given to the band shape portions 22. Further, plural image data showing the positions of the respective pointers 13a, 14a within the rotational movement ranges are prepared and stored in the memory section 61a in advance as pointer image data for displaying pointers 13a, 14a such that appropriate image data can be selected on the basis of the cooling water temperature and the remaining fuel amount.

Furthermore, the above image data are image data for performing the two-dimensional visual display in an area for displaying pointer images 13a, 14a and scale images 13c, 14c, and for performing the three-dimensional visual display in an area for displaying pointer hub images 13b, 14b, symbol mark images 13d, 14d, a dial plate image 13e and an acrylic tone ring image 13f.

Therefore, the pointer images 13a, 14a and the scale images 13c, 14c are displayed two-dimensionally so that resolution thereof will not be reduced. Also, the character image 13e is displayed in the three-dimensional shape having a gentle depth or hollowed appearance. Further, the pointer hub images 13b, 14b, the symbol mark images 13d, 14d and the acrylic tone ring image 13f are displayed in the three-dimensional shapes embossed with respective color tones and quality appearances.

Next, in step S110, it is determined whether an abnormality exists in detecting items of the respective sensors 71 to 76. Further, in step S111, it is determined whether the ignition switch 80 is in an on condition. Thus, if there is no abnormality in the detecting items of the respective sensors 71 to 76 and the ignition switch 80 is on, the above normal display mode is continued.

On the other hand, when it is determined that an abnormality exists in one of the detecting items in the step S110, the processing proceeds to steps S113, S114. Thus, processing for displaying an abnormality display mode is performed.

For example, as shown in FIG. 9, an abnormality message image and a minimum information image relative to the instrument are displayed in the liquid crystal panel 20 as an informing image. In the example of FIG. 9, a symbol mark image 15 is displayed as a specific image of the informing image.

Here, the sensor 75 is for example a release detecting sensor of a parking brake. When the control unit 60 detects that the vehicle is traveling in a state that the parking brake is not released, the display image of the liquid crystal panel 20 is switched to the informing image shown in FIG. 9 for the purpose of giving an urgent warning to the driver.

In this case, image data for making the symbol mark image 15 showing the parking brake as an abnormality item, an abnormality message image 16, an image 17 of a vehicle speed and an image for a virtual image background are read out of the memory section 61a on the basis of abnormality display mode instructions. As such, the informing image shown in FIG. 9 is displayed in the liquid crystal panel 20.

The abnormality message image 16 is made for informing abnormality in characters. For example, a message such as “Please release parking brake” is displayed. The image 17 of vehicle speed shows the information of the vehicle speed required in the vehicle driving operation. The virtual image background image 18 for example has a depth or hollowed appearance as producing display and a gradation pattern with a predetermined color tone.

In addition to this, a display color may be changed in accordance with an urgent degree of an abnormality item, and a warning sound or a voice for arousing attention may be also simultaneously generated from the speaker 70.

Thereafter, when the abnormality is released, the processing proceeds from the step S114 to the steps S106. Thus, the normal display mode from the step S106 to S109 is performed until the ignition switch 80 is turned off.

When it is detected that the ignition switch 80 is turned off at step S111, a good-by message producing display mode is started in step s112.

Similar to the welcome message producing display mode MA shown in FIG. 7, the good-by message producing display mode is the display mode for three-dimensionally displaying the informing image while moving. For example, the character image of “Good-by!”, which is non-vehicle information, is repeatedly displayed while moving from the left-hand side to the right hand-side of the display screen along the horizon that has a greatly embossed appearance, as the specific image. At this time, the horizon and the character image are visualized so as to be embossed from the liquid crystal panel 20 as three-dimensional image. As such, a producing effect can be improved.

Also, the producing effect can be further raised such as by setting the color tones of the horizon, the character and the background area to color tones having contrast, and changing these color tones with the time. Further, at this time, the producing effect can be further raised if the voice message such as “Have a nice day!” or “Thank you for safety drive!” is outputted by a female voice from the speaker 70. In addition to this, the producing effect may be also raised by adding character display of such as an animal and/or a person and embossing this character as a three-dimensional and moving image.

When a series of these operations and the voice output, etc. are terminated, the control unit 60 changes from the Wakeup mode into the Sleep mode and stops the control operation. Further, the control unit 60 further stops the display of the liquid crystal panel 20.

As mentioned above, in the first example embodiment, images of various kinds of indication instruments constituting the combination meter 1 and some producing images are three-dimensionally displayed in the liquid crystal panel 20. Accordingly, an appearance of the combination meter 1 improves. Furthermore, in this case, all image information is not three-dimensionally displayed. Namely, the specific information of the image information, which should be accurately informed to the driver (viewer), as important display information such as indication contents of the indication instrument, e.g., the pointers, the scales, the numbers and the characters, is displayed two-dimensionally without providing the parallax.

Thus, the important display information can be displayed without reducing resolution. Furthermore, even when the visual point of the driver moves leftward or rightward, display image will not be disturbed. Therefore, the information can be accurately projected or informed. In addition, it is less likely that the feeling of physical disorder, which is peculiar to the three-dimensional visual display by using the three-dimensionally visualizing member will be generated. Therefore, the information can be easily seen.

Further, the producing effect and the appearance of the display image can be improved by three-dimensional visual display with the predetermined color tones and the sounds by the display control of the control unit 60, especially, in the welcome message producing mode when the door switch 76 is turned on, the good-by message producing mode when the ignition switch 80 is turned off, the abnormality display mode when the abnormality is detected in the detection items, and in the normal display mode.

Also, in the normal display mode, the image of the indication instrument, such as a real analog meter, having three-dimensional decorative members, can be produced. Furthermore, an three-dimensional quality appearance of the indication instrument can be improved.

### Second Example Embodiment

In the combination meter 1, in displaying the informing image at the predetermined informing time, i.e., in the predetermined informing mode, the informing image or the specific image of the informing image can be displayed as a three-dimensional and moving image, to improve a producing effect and a visual recognition property.

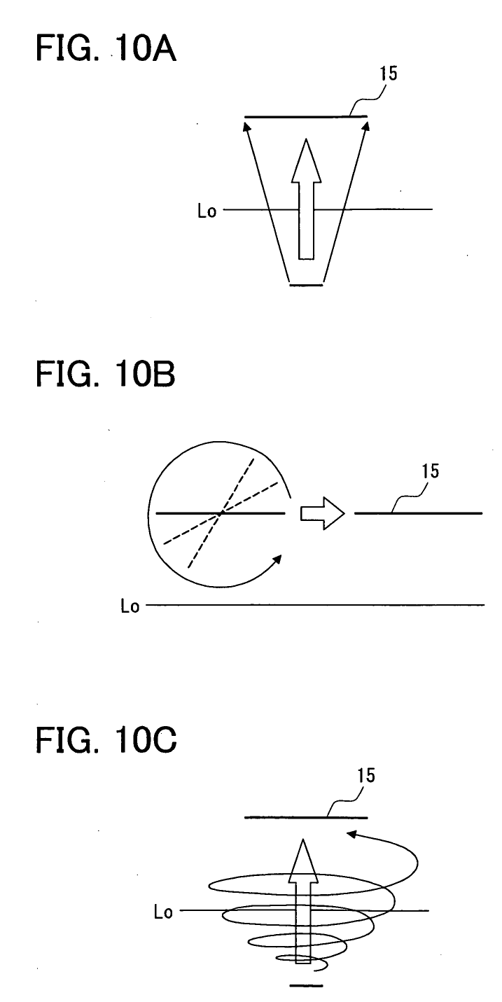

For example, the informing image or the specific image of the informing image can be changed or moved while transitionally moving, rotating, zooming in and out (enlargement and reduction in size) or moving in a depth direction (i.e., in a direction perpendicular to the plane of the display surface), as shown in FIGS. 10A to 10C. Further, the informing image or the specific image of the informing image can be moved by combining some of the above movements.

Hereafter, operation examples for displaying the informing image or the specific information of the informing image as the three-dimensional and moving image will be described. Here, the symbol mark image 15, which is displayed as the abnormality informing message in the step S113, is three-dimensionally displayed while moving as the specific information, for example.

First, FIG. 10A shows an operation example in which the symbol mark image 15 is moved while being enlarged from a distant place (the depth side from the display face L₀) to this side (the upper face from the display face L₀), and is then at rest in this side position, and is flashed (turned on and off) for a predetermined time period. In this case, the visual recognition property of the driver is improved by an urgent feeling produced by the movement on this side and the flashing.

FIG. 10B shows an operation example in which the symbol mark image 15 is rotated at high speed in the same position, then gradually changed to low speed rotation, maintained at rest, and then flashed (turned on and off in display) for a predetermined time period. In this case, the visual recognition property is improved by a distraction feeling produced by the rotation and the flashing.

Further, FIG. 10C shows an operation example in which the symbol mark image 15 is moved while being enlarged and rotated from the distance place (the depth side from the display face L₀) to this side (the upper face from the display face L₀), then maintained at rest in this side position, and is flashed (turned on and off in display) for a predetermined time period. In this case, the visual recognition property is improved by an urgent and distraction feeling produced by the movement on this side, the rotation, and the flashing.

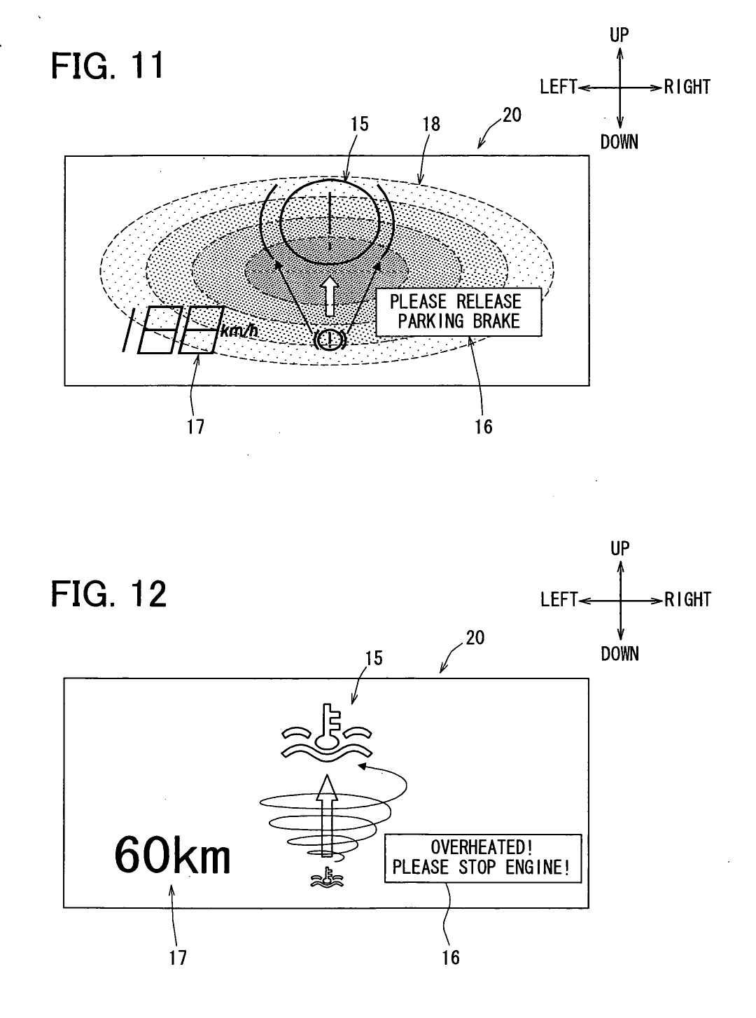

Accordingly, the visual recognition property of the driver can be further improved by employing such moving image displays shown in FIGS. 10A to 10C in production display of the symbol mark image 15, as shown in FIG. 11. FIG. 11 shows an example in which the operation shown in FIG. 10A is employed to display the symbol mark image 15 as the moving image.

In addition to this, for example, when the control unit 60 detects a state that engine cooling water temperature abnormally rises, the display image of the liquid crystal panel 20 may be also switched to the informing image as shown in FIG. 12 for the purpose of giving an urgent warning to the driver.

For example, the symbol mark image 15 is moved as a three-dimensional and moving image from a distant place to this side while being enlarged and rotated, maintained at rest and then flashed (turned on and off in display) for a predetermined time period so that the recognition property of the driver can be raised, as shown in FIG. 10C.

In this case, image data for making the symbol mark image 15 showing the engine cooling water temperature as an abnormality item, an abnormality message image 16 for informing the message such as “Overheated! Please stop vehicle.”, and a vehicle speed image 17 showing vehicle speed information required in a vehicle operation can be read out of the memory section 61a as the informing image on the basis of abnormality display mode instructions, and displayed in the liquid crystal panel 20.

Accordingly, when the informing image is displayed at the predetermined informing time by the display control of the control unit 60, the informing image or the specific image of the informing image (e.g., the symbol mark image and the character image) is three-dimensionally displayed with movement as a manner similar to the welcome message producing display mode when the door switch 76 is turned on, the Good-by message producing display mode when the ignition switch 80 is turned off, and the abnormality display mode for performing display when an abnormality is generated in one of detecting items. As such, the producing effect and the recognition property (easiness in notice) of the driver can be further raised.

Further, in the respective display modes including the normal display mode, the predetermined informing mode and the respective display modes, the synthetic producing effect and appearance are improved by the three-dimensional visual displays with the predetermined color tones and sound.

### Other Example Embodiments

In the above example embodiments, the transparent cover 30 as the three-dimensional visualizing member is arranged to cover the entire display surface of the liquid crystal panel 20. However, the present invention may be also applied to a display device in which the transparent cover 30 is arranged to cover a part of the liquid crystal panel.

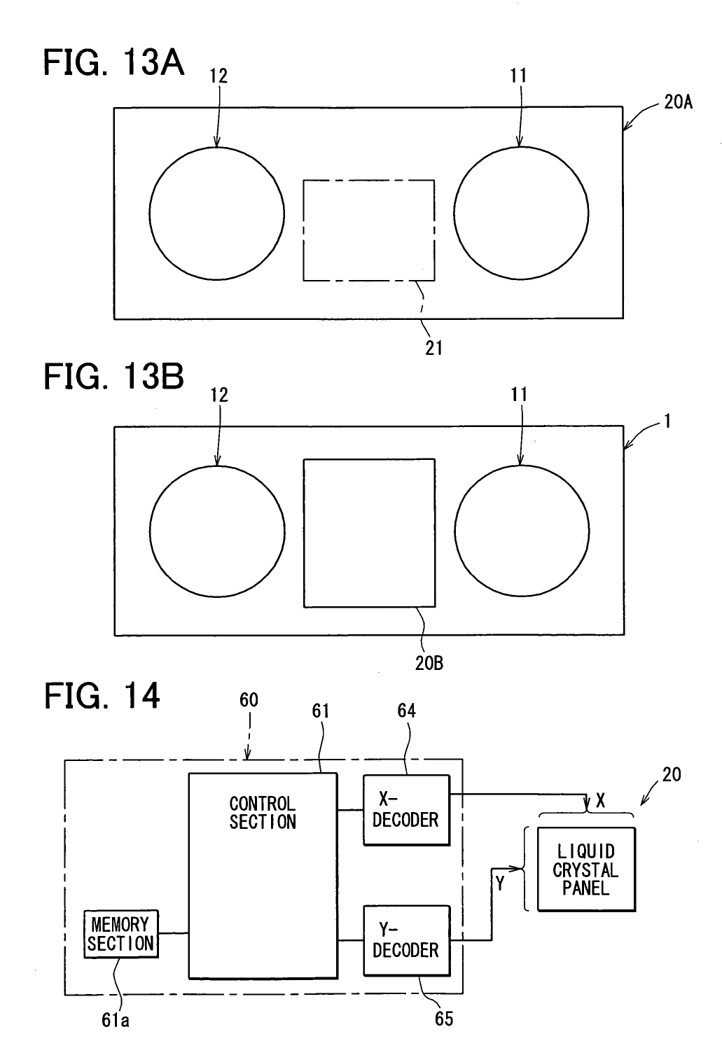

For example, as shown in FIG. 13A, the present invention can be employed to a display device in which a three-dimensional visual display section 21 is constructed by arranging the three-dimensional visualizing member 30 to cover a part of a liquid crystal panel 20A such as at a part between the speed meter 11 and the tachometer 12. In this case, the three-dimensional visual display area of the liquid crystal panel 20A is limited, but display can be performed by appropriately balancing the two-dimensional visual display areas displaying the instrument images that require resolution and the three-dimensional visual display area for improving the producing effect and the visual recognition property.

Further, as shown in FIG. 13B, the present invention may be also applied to a display device in which a liquid crystal panel 20B for three-dimensional visual display is mounted to a partial area of a dial plate of the combination meter 1 having analog type meters 11, 12 instead of the liquid crystal panel 20. In this case, three-dimensional image display for improving the producing effect and the recognition property can be added to the combination meter 1 having analog type meters 11, 12.

In the above example embodiments, the right eye driving section 62 and the left eye driving section 63 are separately provided in the control unit 60, as shown in FIG. 4. The right eye driving section 62 operates the band shape portions 22 of the liquid crystal panel 20, and the left eye driving section 63 operates the band shape portions 21 of the liquid crystal panel 20. In contrast to this, as shown in FIG. 14, the entire liquid crystal panel 20 can be operated by an X-decoder 64 and a Y-decoder 65 without separately providing the right eye driving section 62 and the left eye driving section 63.

In this case, image data of the entire liquid crystal panel including display images of the band shape portions 21 for the left eye and the band shape portions 22 for the right eye can be prepared and stored as a data map within the memory section 61a.

In the above example embodiments, for example, a TFT type liquid crystal display is used as the liquid crystal panel 20 of an indicator 2. However, the indicator 2 can be constructed of other indicators such as organic EL, FED or CRT. Further, a display driving system may be one of an active driving system and a passive driving system.

Further, in the above example embodiments, parallax slit members are formed on the transparent cover 30 as the three-dimensional visualizing member. However, similar effects can be obtained when a lenticular lens member having many semispherical lenses arranged in the transversal direction is used.

Furthermore, the method for performing the three-dimensional visual display is not limited to the method using the parallax method such as the parallax barrier method and the lenticular lends method. The three-dimensional visual display can be performed by various methods. For example, another member such as a half mirror or a mirror can be used as the three-dimensionally visualizing member, i.e., the three-dimensional image forming member. The three-dimensional image can be produced by overlapping a virtual image, which is reflected by the half mirror or the mirror, on a real image displayed on the display panel.

In addition, in the above example embodiments, the present invention is applied to the combination meter 1 for a vehicle. However, the use of the display device of the present invention is not limited to the combination meter of the vehicle. The present invention can be applied to general instrument and display device in which a viewer can see display contents from its front face.

Further, in the above example embodiments, the vehicle information of the combination meter 1 is set to the speed meter 11, the tachometer 12, the water temperature meter 13 and the fuel gauge 14. However, the vehicle information is not limited to the above. For example, other display meters such as an odometer, a speed change shift position display device and a vehicle exterior temperature meter can be added and/or replaced into one of or some of the above vehicle information.

Also, in the above example embodiments, as shown in FIG. 8, the pointers 11a to 14a of the respective instruments 11 to 14 are entirely displayed. However, an indication position can be also accurately displayed when only tip portions of the pointers 11a to 14a are two-dimensionally displayed as shown in pointer shape display MG of FIG. 5 and the display area B of FIG. 3.

The example embodiments of the present invention are described above. However, the present invention is not limited to the above embodiments, but may be implemented in other ways without departing from the spirit of the invention.

What is claimed is:

1. A display device comprising:
an indicator having a display element for displaying image information, the indicator having a flat plate shape; and
a control unit for controlling the indicator to perform a three-dimensional visual display such that an image is three-dimensionally visualized and a two-dimensional visual display such that an image is two-dimensionally visualized, wherein
the indicator performs the two-dimensional visual display with respect to specific information of the image information.

2. The display device according to claim 1, wherein the image information other than the specific information is three-dimensionally displayed.

3. The display device according to claim 1, wherein the specific information includes at least one of a physical value and a character.

4. The display device according to claim 1, wherein the indicator has a three-dimensionally visualizing member disposed on a side of the display element to visualize an image three-dimensionally.

5. The display device according to claim 1, wherein the indicator performs the three-dimensional visual display by providing a parallax of a right eye and a left eye of a viewer.

6. The display device according to claim 5, wherein the indicator has a three-dimensionally visualizing member disposed on a surface of the display element to visualize an image displayed on the display element three-dimensionally by the parallax of the right and left eyes.

7. The display device according to claim 6, wherein the three-dimensionally visualizing member is disposed to entirely cover the surface of the display element.

8. The display device according to claim 6, wherein
the control unit controls the display element to display a right eye image and a left eye image, and
the three-dimensionally visualizing member is disposed such that the right eye image is seen by the right eye and the left eye image is seen by the left eye through the three-dimensionally visualizing member.

9. The display device according to claim 8, wherein the display element displays the right eye image and the left eye image as different images, thereby to provide the parallax.

10. The display device according to claim 8, wherein the display element displays the right eye image and the left eye image as the same image, thereby to perform the two-dimensional visual display.

11. The display device according to claim 1, wherein the control unit controls the display element to perform the three-dimensional visual display in a first display area of the display element and the two-dimensional visual display in a second display area of the display element.

12. The display device according to claim 1, wherein the indicator displays an image of an instrument that indicates detected information.

13. The display device according to claim 12, wherein the instrument has a decorative portion and a producing portion, and at least one of the decorative portion and the producing portion is three-dimensionally displayed.

14. The display device according to claim 12, wherein the instrument is an indication instrument having a pointer for indicating the detected information, and at least an end of the pointer is two-dimensionally displayed.

15. The display device according to claim 12, wherein the detected information includes information relative to a vehicle, and the indicator is arranged in an instrument panel of the vehicle, in front of a driver's seat of the vehicle.

16. The display device according to claim 6, wherein the three-dimensionally visualizing member includes one of a parallax slit member and a lenticular lens member.

17. A display device comprising:
an indicator having a display element for displaying image information, the display element having a flat plate shape; and
a control unit for controlling the indicator to perform a three-dimensional visual display such that an image is three-dimensionally visualized and a two-dimensional visual display such that an image is two-dimensionally visualized, wherein
the control unit controls the indicator to display an informing image as a three-dimensional and moving image at a predetermined informing time.

18. The display device according to claim 17, wherein the indicator has a three-dimensionally visualizing member disposed on a side of the display element to visualize an image three-dimensionally.

19. The display device according to claim 17, wherein the indicator performs the three-dimensional visual display by providing a parallax of a right eye and a left eye of a viewer.

20. The display device according to claim 19, wherein the indicator has a three-dimensionally visualizing member disposed on a surface of the display element to visualize an image displayed on the display element three-dimensionally by the parallax of the right and left eyes.

21. The display device according to claim 17, wherein the indicator performs the two-dimensional visual display with respect to a specific information of the image information, the specific information being required to be accurately informed to the viewer.

22. The display device according to claim 21, wherein the specific information includes at least one of a physical value and a character.

23. The display device according to claim 17, wherein the control unit controls the indicator such that the informing image has at least one of a transitional motion, a rotating motion, a zooming motion and a flashing motion.

24. The display device according to claim 17, wherein the control unit controls the indicator such that a specific image of the informing image has at least one of a transitional motion, a rotating motion, a zooming motion and a flashing motion.

25. The display device according to claim 17, wherein one of the informing image and a specific image of the informing image is flashed for a predetermined time period after a movement thereof is stopped once.

26. The display device according to claim 20, wherein
the control unit controls the display element to display a right eye image and a left eye image, and
the three-dimensionally visualizing member is disposed such that the right eye image is seen by the right eye and the left eye image is seen by the left eye through the three-dimensionally visualizing member.

27. The display device according to claim 26, wherein the display element displays the right eye image and the left eye image as different images, thereby to provide the parallax.

28. The display device according to claim 26, wherein the display element displays the right eye image and the left eye image as the same image, thereby to perform the two-dimensional visual display.

29. The display device according to claim 17, wherein the control unit controls the display element to perform the three-dimensional visual display in a first display area of the display element and the two-dimensional visual display in a second display area of the display element.

30. The display device according to claim 17, wherein the indicator displays an image of an instrument that indicates detected information.

31. The display device according to claim 30, wherein the instrument has a decorative portion and a producing portion, and at least one of the decorative portion and the producing portion is three-dimensionally displayed.

32. The display device according to claim 20, wherein the three-dimensionally visualizing member is disposed to cover at least a part of the surface of the display element.

33. The display device according to claim 17, further comprising:
a display panel for defining a display area; and
an instrument for indicating information, wherein
the indicator is disposed adjacent to the instrument in the display area of the display panel.
